(19) United States
(12) Patent Application Publication
(10) Pub. No.: US 2010/0124181 A1
(43) Pub. Date: May 20, 2010

(54) System and Method for Managing a Wireless Communications Network

(75) Inventor: Patrick Ahamad Hosein, San Diego, CA (US)

Correspondence Address: Slater & Matsil, L.L.P., 17950 Preston Road, Suite 1000, Dallas, TX, 75252, US

(73) Assignee: FUTUREWEI TECHNOLOGIES, INC., Plano, TX (US)

(21) Appl. No.: 12/619,266

(22) Filed: Nov. 16, 2009

Related U.S. Application Data
(60) Provisional application No. 61/115,423, filed on Nov. 17, 2008.

(51) Int. Cl. H04L 12/26; H04B 7/00; H04B 7/208; H04W 4/00

(52) U.S. Cl. 370/252; 455/509; 370/344; 370/329

(57) ABSTRACT

In an embodiment, a method of operating a base station configured to support a plurality of user devices on a plurality of channels is disclosed. The method includes finding an interference level for each channel, comparing the interference level for each channel with an interference threshold, and determining up to a first number of channels whose interference metric exceeds the interference threshold to determine a set of unsuitable channels. The method also includes determining a set of usable channels, where the usable channels include the plurality of channels that are not determined to be unsuitable channels. The usable channels are allocated to the plurality of user devices.

### CROSS REFERENCE TO RELATED APPLICATION

This patent application claims priority to U.S. Provisional Application No. 61/115,423 filed on Nov. 17, 2008, entitled “Self Optimizing, Distributed Interference Management for the OFDMA Downlink Channel,” which application is hereby incorporated by reference herein.

### TECHNICAL FIELD

The present invention relates generally to wireless communication systems, and more particularly to a system and method for managing a wireless communications network.

### BACKGROUND

Wireless communication systems are widely used to provide voice and data services for multiple users using a variety of access terminals such as cellular telephones, laptop computers and various multimedia devices. Such communications systems can encompass local area networks, such as IEEE 801.11 networks, cellular telephone and/or mobile broadband networks. The communication system can use one or more multiple access techniques, such as Frequency Division Multiple Access (FDMA), Time Division Multiple Access (TDMA), Code Division Multiple Access (CDMA), Orthogonal Frequency Division Multiple Access (OFDMA), Single Carrier Frequency Division Multiple Access (SC-FDMA) and others. Mobile broadband networks can conform to a number of system types or partnerships such as, General Packet Radio Service (GPRS), 3rd-Generation standards (3G), Worldwide Interoperability for Microwave Access (WiMAX), Universal Mobile Telecommunications System (UMTS), the 3rd Generation Partnership Project (3GPP), Evolution-Data Optimized EV-DO, or Long Term Evolution (LTE).

An illustration of a conventional mobile broadband system 100 is depicted in FIG. 1. Mobile broadband system 100 is divided into cells 108, 110 and 112, where each cell 108, 110 and 112 has corresponding base station 102, 104 and 106. Mobile terminals or user devices 116 and 114 access network 100 through one of base stations 102, 104 and 106. Three base stations 102, 114 and 106 and two user devices 114 and 116 are used for simplicity of illustration, however, multiple cells and user devices can be used and provided for in real systems. In system 110, user device 114 operates on the periphery of cell 108, and is referred to as a cell edge device. Because of interference from base stations 104 and 106 in cells 110 and 112, user device 114 may experience lower signal to noise and distortion in its communication with base station 102. One way in which acceptable performance is maintained for cell edge devices is to apply interference management methods such as frequency reuse techniques.

OFDMA is the chosen downlink radio transmission technology for the next generation of mobile communication systems such as IEEE 802.16 and LTE (Long Term Evolution (LTE). OFDMA offers flexible bandwidth support, high spectral efficiency and Multi-Input Multi-Output (MIMO) support. Intra-cell interference is avoided by scheduling at most one user in each time-frequency resource block (RB). However if a frequency reuse factor of one is used, then transmissions in adjacent sectors may cause significant interference. If a frequency reuse factor of three is used instead, then inter-cell interference can be reduced but comes at the cost of capacity loss because of the reduced number of RBs available at each sector.

There are two basic prior art approaches to dealing with the problem of frequency reuse, Soft Frequency Reuse (SFR) and Partial Frequency Reuse (PFR). In the SFR approach a subset of the frequency band is reserved for serving cell edge users. Typically this is one third of the total bandwidth. This subset is allocated with a frequency reuse factor of three so that three adjacent sectors use different parts of the bandwidth. The remaining bandwidth in each sector is used by the cell center users and the frequency partition used by cell edge users in one sector can also be used by cell center users in an adjacent sector. The edge users are served with higher power than the center users but the total transmitted power is maintained at a fixed level. If RBs reserved for cell edge users are not needed, they can be allocated to a cell center user. Because of the fixed partition of resources this approach cannot easily adapt to the wide variety of user populations, locations and QoS needs.

In the PFR approach, a subset of the bandwidth is also reserved for the edge users. This subset is further divided into three with each of the three portions being assigned to adjacent sectors so that a frequency reuse of three is achieved for the edge users. The cell center users are allowed to use the remaining bandwidth in each sector. The PFR approach, however, is not easily adaptable to the many possible variations of user populations, locations and QoS needs.

### SUMMARY OF THE INVENTION

In accordance with an embodiment of the present invention, a method of operating a base station configured to support a plurality of user devices on a plurality of channels is disclosed. The method includes finding an interference level for each channel, comparing the interference level for each channel with an interference threshold, and determining up to a first number of channels whose interference metric exceeds the interference threshold to determine a set of unsuitable channels. The method also includes determining a set of usable channels, where the usable channels include the plurality of channels that are not determined to be unsuitable channels. The usable channels are allocated to the plurality of user devices.

In accordance with another embodiment of the present invention, a method of operating a wireless network configured to operate on a plurality of subbands includes finding an average interference metric for each subband and comparing the average interference metric for each subband with an interference threshold. A set of unsuitable subbands is determined by determining up to a first number of subbands whose interference metric exceeds the interference threshold, and a set of usable subbands is determined, where the usable subbands include the plurality of subbands that are not determined to be unsuitable subbands. The usable subbands are allocated to user devices.

In accordance with another embodiment of the present invention, a wireless base station includes a transmitter configured to transmit to user devices, and a receiver configured to receive transmissions from user devices. The base station is configured to operate on a plurality of channels, find an average interference metric for each channel, and compare the average interference metric for each channel with an interference threshold. The base station is further configured to determine up to a first number of channels whose interference metric exceeds the interference threshold to determine a set of unsuitable channels, and to determine a set of usable channels, wherein the usable channels include the plurality of channels that are not determined to be unsuitable channels. The base station further allocates the usable channels to user devices.

In accordance with an embodiment of the present invention, a wireless user device includes a transmitter and a receiver. The wireless user device is configured to measure an interference level in a plurality of subbands and operate with a network. The network is configured to operate on the plurality of subbands and find an average interference metric for each subband by polling the wireless user device for a measured interference metric. The network is further configured to compare the average interference level for each subband with an interference threshold and determine up to a first number of subbands whose interference metric exceeds the interference threshold to determine a set of unusable subbands. The network determines a set of usable subbands, where the usable subbands include the plurality of subbands that are not determined to be unsuitable subbands. The user device is configured to receive an allocation of at least one of the usable subbands from the network.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a diagram of a conventional mobile broadband system;

FIGS. 2 and 3 illustrate graphs showing the performance of an embodiment simulation;

FIG. 4 illustrates a block diagram of an embodiment base station;

FIG. 5 illustrates a block diagram of an embodiment user device;

FIGS. 6-8 illustrate performance curves of an embodiment system;

FIG. 9 illustrates a bar chart showing subband allocation among multiple cells for an embodiment system; and

FIG. 10 illustrates subband allocation among multiple cells for each subband for an embodiment system.

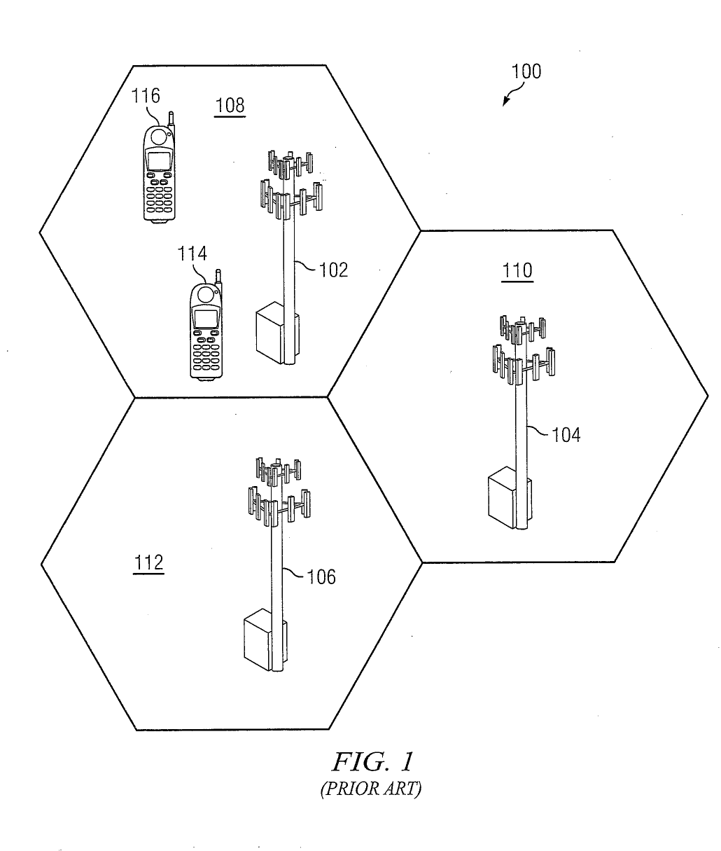

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of various embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to various embodiments in a specific context, namely interference management in wireless networks. The invention may also be applied to resource management in other types of networks.

In embodiments of the present invention, a distributed algorithm is used by each sector in a wireless network to determine an appropriate frequency reuse factor. Embodiment algorithms achieve acceptable interference levels at the edge of each cell and provide fair resource allocation among sectors. In embodiments, cross-sector fairness is maintained so that a sector's throughput is not sacrificed while maintaining low cell edge interference levels at neighboring sectors.

According to an embodiment of the present invention, bandwidth utilization v. system loading is considered in determining a frequency reuse method. It can be shown that under light loading conditions, a frequency reuse factor of unity may be optimal, but this is not necessarily the case for a heavily loaded network.

Assume that each sector can use at most a total bandwidth B and that a single user is scheduled in each sector. This bandwidth can be divided up among adjacent sectors to reduce interference. Assume that the bandwidth is divided equally among n sectors so that each sector experiences no interference from its closest n−1 neighbors. However, there is still interference from other sectors. The interference can be estimated as follows. Let A denote the area of a sector so that the radius r of the area covering the non-interfering sectors is given from the relationship An=πr2, and assume that the sectors using the same band within a distance of ε outside this region interferes with the concerned sector. Furthermore, assume that the interference falls inversely with the distance to the power of 3. The total interference is approximated as the product of the number of sectors in the surrounding ring 2πrε/(An) times the loading ρ for the subband (i.e., the probability that the sector allocated to the subband actually uses it) times the interference caused by each nPr^{-3.5}, where P is the transmission power. Background noise is denoted by N₀, and the path gain for the user served in the concerned sector is denoted by g. If the power density available for the whole band is P then for the subband it is nP. Shannon capacity for the served user can be determined to be:

$$R = \frac{B}{n} {log}_{2} ( 1 + \frac{nPg}{{N}_{0} + \frac{2 π r ɛ}{An} {Pr}^{- 3.5}} ) .$$

Setting r=\sqrt{An/π} and normalizing the rate with respect to bandwidth, the following expression is obtained:

$$R = \frac{1}{n} {log}_{2} ( 1 + \frac{an}{1 + {pbn}^{- 1.25}} ) , \qquad ( 2 )$$

where the parameters a and b can be determined from the constants P, g, A, N0, ε and π.

Values for a and b are derived as follows. Assuming the interference becomes comparable to the background noise when a re-use factor of n=6 is used. Therefore b≈6^{1.25}, and so b=10 is used. If it is assumed that the entire bandwidth is used for the mobile device, the SNR achieved by the mobile device (i.e., without interference) is 10 dB, resulting in a=10. These values are used together with a loading factor of ρ=1 as the baseline problem.

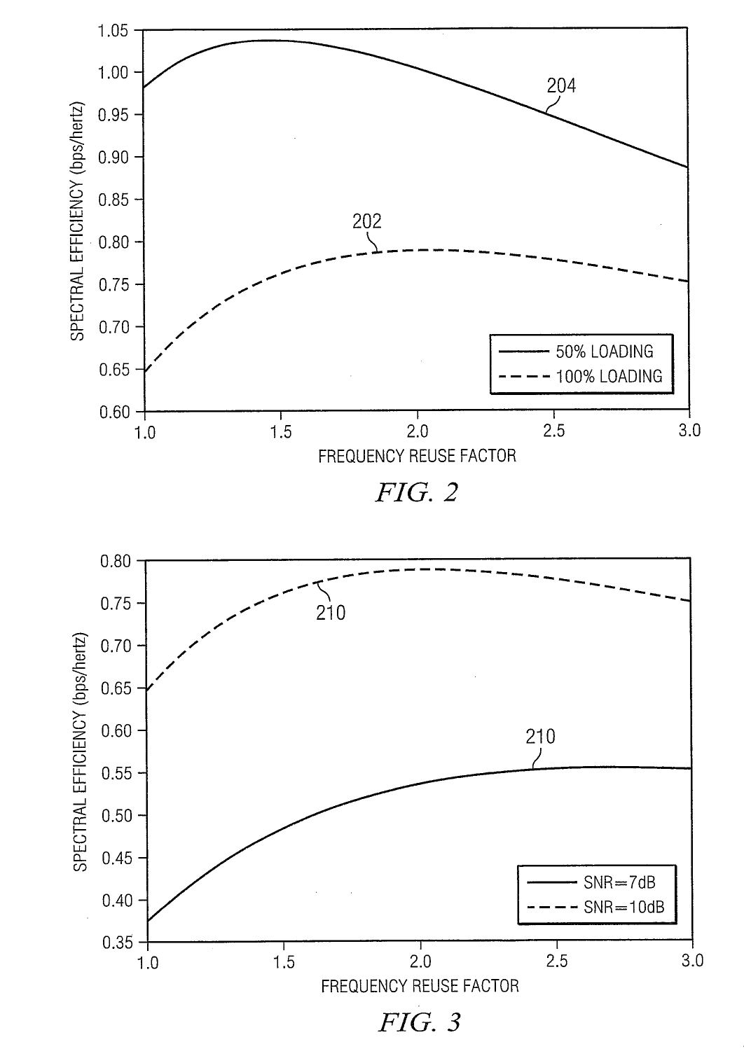

In an embodiment, the effect that loading has on the optimal reuse factor is considered. In FIG. 2 the baseline case of a ρ=1 loading factor is plotted as curve 202 and the case in which the loading factor is reduced to ρ=0.5 is plotted as curve 204. The horizontal axis represents the FFR (Fractional Frequency Reuse) factor, while the vertical access represents the spectral efficiency of the transmission to the user in the concerned sector. It can be seen that the spectral efficiency for the transmission to the user is higher for the lighter loading case (less interference). It can be further seen that the optimal fractional frequency reuse factor moves from about 2 for the baseline case to about 1.4 for the reduced loading case. In general, higher loading is better supported with a higher FFR, which in turn means lower bandwidth utilization. The opposite also is true for very lightly loaded cases in which each sector can use all available bandwidth.

In an embodiment, the effect of how user position in the sector affects the optimal FFR factor is investigated. In FIG. 3, the baseline case is plotted as curve 210 and the case where the user's SNR is 3 dB lower (closer to the cell edge) than the baseline case is plotted as curve 212. Note that the optimal FFR factor increases as the mobile approaches the cell edge. Therefore, users near the center use a FFR factor of 1 while those at the edge use higher FFR factors.

In the previous illustrative example, if the FFR factor n was greater than one then once a frequency resource is allocated to a user in a sector, it cannot be allocated to any of the n−1 closest neighbors of the sector. Therefore, another embodiment consideration is which of these n sectors should be allowed to use the resource and, for the chosen sector, what power should be allocated to the transmission. Transmissions within a chosen resource block (i.e., fixed bandwidth) are considered. For the two-sector case, it can be shown that to maximize throughput, either one of the sectors or both of the sectors transmit to the user with the maximum allowed power. Unfortunately this does not hold for the case of more than two sectors but it can be shown that the solution obtained by using this binary power allocation (i.e. each sector uses zero or maximum power for its transmission) is near optimal. Some embodiment systems and methods therefore assume that for each RB, each sector transmits with maximum power to the mobile scheduled for the RB, or does not schedule a mobile in the RB. Alternatively, other embodiments can make other assumptions.

Given binary power allocation, a sector will serve users over a subset of its resource blocks. However, the particular set of resource blocks will depend on the power that is allocated to each block. Ideally, the objective function should be jointly optimized over both frequency resources and power resources, but this problem can become complicated. The following embodiment case is, therefore, addressed. Consider any two resource blocks a and b that are used by the sector and users i and j are allocated to these resource blocks respectively. Denote the channel gain for user i over resource block a by gia, and similarly define the other channel gains. Flat fading across both RBs is assumed, and hence the simplified notation gi=gia=gib and gj=gja=gjb is used. Ia and Ib denote the interference values of these resource blocks. In an embodiment, the interference level for a RB is the same for all users, and hence the mobile with the highest achievable SINR over the RB is the one with the highest channel gain. Suppose that gi≧gj, then if b is allocated to i the resulting rate achieved over b is at least as high as when it was allocated to j. Hence the overall throughput can be increased (or at least remains the same) if b is also allocated to i. It can be concluded that throughput can be maximized by assigning the user with the higher SINR to both RBs.

Note, however, that although user i has the same channel gains over both RBs, the interference values may be different and the SINR values may be different. This means that, in an embodiment, in order to maximize throughput, different powers are allocated to each block. Assume that the total power available for both blocks is P and denote the individual powers by pᵢₐ and p_{ib}. Note that the rate achieved over a block increases with the allocated power. This means that the power constraint is binding and hence pᵢₐ+p_{ib}=P. The notation is simplified by denoting pia=pi and p_{ib}=P−pᵢ.

The two-sector case is considered and the user allocated over the two blocks in the neighboring sector is denoted by k. The channel gains for this user, which is the same for each block, are denoted by gₖ. The cross-sector channel gain from the concerned sector to the user in the neighboring sector will be denoted by hᵢₖ and hₖᵢ is defined similarly. The powers allocated in the neighboring sector are denoted as pₖ for resource block a and as P−pₖ for resource block b. The background noise of block a in the concerned sector is assumed to be the same as for block b and will be denoted by Nᵢ. In the interfering sector, the background noise is denoted by Nₖ. Note that in a homogeneous, well-balanced network, the interference from the other sectors in the network will be the same over each block. If this is the case, then this component can be included in the background noise. Therefore, although only two sectors are considered, other sectors can be accounted for as well (under the balanced loading assumption) in embodiments of the present invention.

The total rate achieved in the concerned sector can be determined as

$${R}_{i} = {log}_{2} ( 1 + \frac{{p}_{i} {g}_{i}}{{N}_{i} + {p}_{k} {h}_{ki}} ) + {log}_{2} ( 1 + \frac{( P - {p}_{i} ) {g}_{i}}{{N}_{i} + ( P - {p}_{k} ) {h}_{ki}} ) . \qquad ( 3 )$$

In some embodiments, the above expression operates under the constraint that pᵢₐ+p_{ib}=2P. In an embodiment, the power allocation that maximizes this rate is obtained from water-filling (essentially setting both gradients equal given the power constraint) to obtain:

$${p}_{i} = \frac{P}{2} + \frac{( P - 2 {p}_{k} ) {h}_{ki}}{2 {g}_{i}} . \qquad ( 4 )$$

Since the neighboring sector also maximizes its throughout then it will also compute the optimal power allocation. For that sector the following is obtained:

$${p}_{k} = \frac{P}{2} + \frac{( P - 2 {p}_{i} ) {h}_{ik}}{2 {g}_{k}} . \qquad ( 5 )$$

Substituting for pₖ in the equation for pᵢ and solving for pᵢ, pᵢ=P/2 is obtained. In other words the available power is spread equally between the two resource blocks. In an embodiment, this can be repeated for any two allocated resource blocks to conclude that the total power can be evenly spread among all resource block transmissions of the sector.

In some embodiments, this equilibrium point (Nash Equilibrium) is not necessarily optimal since it might be better for one sector to allocate all power to one RB while the other allocates all power to the other. Note that there are two possibilities, only one of which will typically be optimal. By using power control, the steady state solution has this property. However, in some embodiments, this limiting solution is equally likely to be either of the two options, which can be seen as follows. Suppose that sector 1 has a high channel gain for RB a, and a low channel gain for RB b. Assume that the opposite is true for sector 2. The optimal solution for these embodiments is for sector 1 to only use RB a, and for sector 2 to only use channel b. Suppose that the system is in equilibrium with uniformly distributed power, but that there is a small perturbation whereby the channel gain for RB a in sector 1 decreases. With power allocation, this causes a reduction in power for this RB and an increase in power for RB b in sector 1. This, in turn, causes an increase in power in sector 2 for RB a and a decrease for RB b. The increase in interference for RB a in sector 1 means a further reduction in power. The process repeats until all power in sector 1 is allocated to RB b and all power in sector 2 is allocated to RB b, which is not optimal for these particular embodiments. Note, however that the system can similarly converge to an optimal solution. Hence, the embodiment system is maintained at the equilibrium point corresponding to uniform power allocation by maintaining uniform power allocation with no power control.

This embodiment approach also has an advantage that the interference over each RB is determined by which sectors use the RB, as well as by the power levels of the transmissions in these sectors. Therefore, if the sectors that use the RB are fixed, and if transmission power levels they use are fixed, the interference variation is reduced when compared to the power control case. This ensures more accurate channel quality reports, thereby improving system performance for this embodiment.

In embodiment systems and methods, intra-sector fairness (fairness among users scheduled within a sector) and inter-sector fairness (fairness among users from different sectors) are taken into account. In particular, the base station scheduler handles intra-sector fairness.

One definition of fairness is that all sectors are allowed to use the same amount of time/frequency/power resources. For example, if interference is high then all sectors should use at most 80% of their bandwidth in order to limit interference levels. One problem with this approach is that for inhomogeneous user distributions resources may be wasted. For example if one region has a high user density while another has a low user density, then the frequency reuse factor should be higher in the higher density region than in the lower density region. In embodiments, a smaller fraction of the available bandwidth is, therefore, allocated to those sectors in the high-density region than those in the low-density region. In this case, fairness is maintained in that the allocation of more resources to users in the low-density region does not adversely affect the performance of those users in the high-density region.

Generally, one objective of interference coordination is limiting the interference experienced by cell edge users, thereby allowing them to achieve acceptable data rates. Therefore, fairness can also be defined, as the allocation of resources to sectors such that the maximum interference experienced by any mobile is at most some specified value. This specified value will determine the trade-off between fairness and sector throughput. If this limit is very high, then each sector will use almost all available resources and achieve high sector throughputs, but the cell edge users will perform poorly. If the limit is low, then few bandwidth resources will be used in each sector thus limiting overall sector throughput. The reduced interference, however, will help the performance of the edge users. In an embodiment, a suitable limit is determined by the type of application supported and by the associated QoS guarantees that are provided regardless of where the mobile lies within the cell. For example, for Voice over IP (VoIP) users, the maximum interference level is determined by an outage criterion.

Embodiment systems and methods take into account both of the above fairness criteria as follows. First, the second fairness criterion is used and an upper limit on the interference levels of the edge users is maintained. This is accomplished by having each sector independently change the fraction of bandwidth that it uses for transmissions. Since this results in different sectors using different bandwidth fractions, a lower limit is placed on this fraction. If this lower limit on the fraction of bandwidth used is very small, then the interference criterion is more easily satisfied but the bandwidth used (and hence throughput achieved) by different sectors may differ drastically. If, on the other hand, the limit is large then all sectors have comparable resource allocation, but the maximum interference limit criterion may be violated.

In the above discussion, it is assumed that power is equally divided among all resource blocks and bandwidth was used to adjust interference levels. Embodiment systems and methods can also use all bandwidth resources and adjust power to adjust interference levels. More power can be applied for edge users than center users, but this needs user partitioning of users. The partition used by one sector influences the interference levels experienced by its neighbors.

In an embodiment, as the loading increases within a region of the network, each sector in the region reduces the number of resource blocks used for serving its users. For lightly loaded regions, each sector in the region increases the number of resource blocks used for serving its users

In an embodiment, the scheduler continues to use the criteria for serving users that are used if no interference management is performed and frequency selective scheduling is not affected. Furthermore, user devices near the cell edge achieve higher FFR factors than those close to the center.

In an embodiment, the following model (based on the Long Term Evolution (LTE) standard) is assumed. It is assumed that N=48 resource blocks within each subframe and that at most one user can be allocated to a resource block but that multiple of them can be allocated to a mobile. Each resource block consists of consecutive subcarriers and spans all symbols of the subframe. A collection of S=4 consecutive resource blocks form a subband for a total of K=N/S=12 subbands. Channel Quality Information (CQI) reporting and scheduling remains the same. However, each mobile also periodically determines the intercell interference level experienced in each subband. This is also reported periodically (but at a much lower reporting rate than CQI reports). For each band b, a sector takes the average over all users of the reported interference levels for that band. Alternatively, other system assumptions can be made, such as the number of users and number of resource blocks, for example.

Consider a particular sector and denote the average interference level by γ_{b} of a particular sector. This reflects the loading of this band. Based on the required performance for cell edge users, an interference threshold T_{if} is specified. For each sector if γ_{b}>T_{if} then band b is not allocated for transmissions, otherwise it can be allocated. In order to prevent specific sectors from blocking too many subbands (and hence sacrificing sector throughput) a lower bound T_{sb} is placed on the number of bands that can be blocked. In an embodiment, if the number of subbands with average interference levels greater than T_{if} exceeds T_{sb}, then only the bands with the T_{sb} highest interference levels are blocked. Pseudo-code executed by each sector that implements an embodiment algorithm is as follows:

N = number of users;
B = number of subbands;
sb = 1 for b = 1 : B;
Tif = interference threshold;
Tsb = subband threshold;
γib = Interference of mobile i in subband b;
$γ b = \frac{1}{N} {\sum }_{i = 1}^{N} {γ}_{ib}$
for k = 1 : Tsb;

if (max_{b}{γ_{b}} > Tif) {

m = argmaxb{γb};
sₘ = 0;
γₘ = 0;

end;

end;
Schedule users over subbands b for which s_{b} = 1;

In an embodiment of the present invention, the base station polls user devices to determine γib in each user device for all available subbands b. The algorithm then calculates an average interference

$$γ b = \frac{1}{N} {\sum }_{i = 1}^{N} {γ}_{ib}$$

for each available subband by averaging the interference of each of the N user devices for each subband. The pseudo-code determines a maximum interference level greater than the interference threshold value T_{if} for each subband having an average interference level greater than the interference threshold T_{if} up to a number of times equal to the subband threshold Tsb. Each of these subbands are removed from consideration by setting a corresponding indices, sₘ and γₘ equal to zero. The embodiment pseudo-code is one of many ways embodiment algorithms can be implemented. Alternatively, embodiment algorithms can be implemented differently, for example, if information exchange among basestations is permitted, then one may implement a centralized solution whereby global information is used to determine the subbands that each basestation is allowed to use. In embodiments, the pseudo-code implemented as software and is executed by a base station processor in the base station unit for each cell. Alternatively, the pseudo-code algorithm can be executed in hardware, or by using other methods known in the art.

In an embodiment, if interference is not reported, the reported channel quality information (CQI) can be used to estimate loading. It is assumed that a channel quality indicator can be mapped to an SINR value, and that the variation of the channel quality across bands is much less than the variation in the interference levels across bands since the interference level changes each time user allocations in neighboring sectors are changed. It is also assumed that the noise level is the same in each subband. Under these conditions the SINR value of a subband increases inversely with the interference level of the band. Therefore, for each user, the band with the smallest SINR value is the one with the largest interference level. In embodiments of the present invention, an average of the reported SINR values is found for each subband. The subbands are then from smallest to largest SINR used as a loading order.

Given the set of usable subbands, each sector makes scheduling decisions in the same manner that it does when all subbands are usable. The subbands used by users near the cell edge will typically achieve a frequency reuse factor greater than one, while those near the center will achieve factors close to one. This can be explained as follows. Assume that mobile scheduling priorities are proportional to their channel gains (e.g., this is the case for a Proportional Fair scheduler in which case the scheduling priority is proportional to the channel gain and inversely dependent on the user's throughput). Consider an embodiment example with two users: one near the cell edge and one near the center. In order to serve the cell edge user, an embodiment allocation will typically be made in a subband with low interference because the mobile may be unreachable in the other subbands because of the lower channel gain and high interference in those subbands. On the other hand, the difference in interference levels among the different bands for the center cell mobile can be small because of its distance from the neighboring sectors, and hence the mobile is likely to be scheduled in any of the subbands. Since the low interference subbands are used by the cell edge users, the cell center users will typically be served in the subbands not being used for the cell edge users (i.e., those with a high probability of being used in neighboring sectors and hence low frequency reuse factors).

Furthermore, consider another embodiment example where only cell edge users have high interference levels. Because of the interference threshold used in determining usable bands, only a small number of subbands will be used to serve these users leading to a small bandwidth utilization (large reuse factor). On the other hand, the opposite is true if all users are near the cell center. In the case of a mix of center and edge users, the number of usable subbands depends on the distribution of the users because the interference loading is averaged across them. Therefore, the bandwidth utilization will depend on the distribution of the user locations as well as the user loading in adjacent sectors.

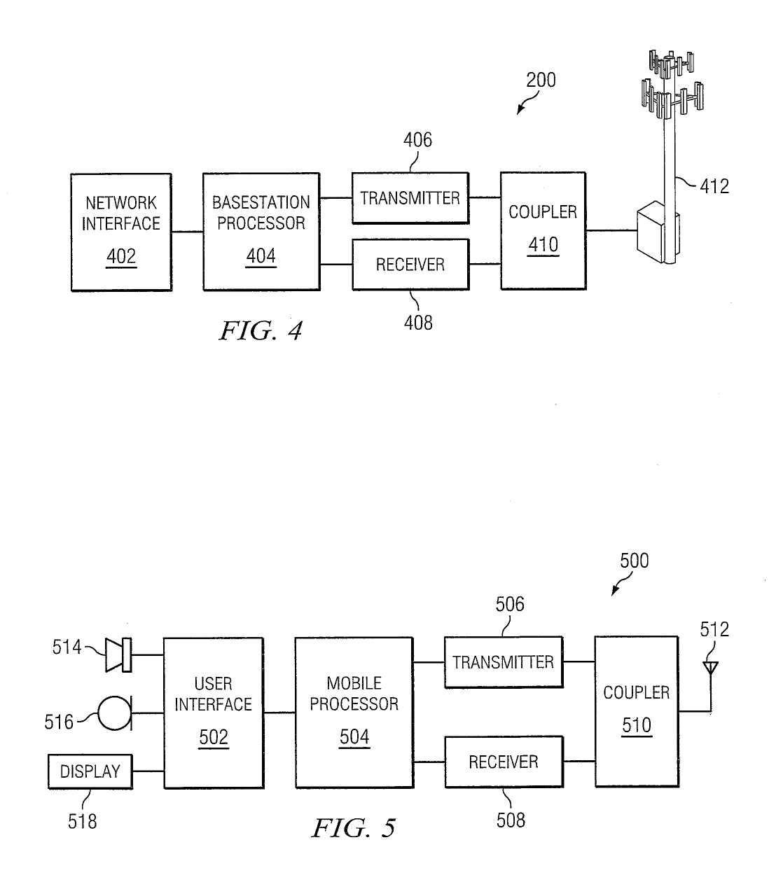

A block diagram of an embodiment base station 400 is illustrated in FIG. 4. Base station 400 has a base station processor 404 coupled to transmitter 406 and receiver 408, and network interface 402. Transmitter 406 and receiver 408 are coupled to antenna 412 via coupler 410. Base station processor 404 executes embodiment frequency reuse algorithms. In embodiments of the present invention, base station 400 is configured to operate in a LTE network using an OFDMA downlink channel divided into multiple subbands. In alternative embodiments, other systems, network types and transmission schemes can be used.

A block diagram of an embodiment user device 500 is illustrated in FIG. 5. User device 500 can be implemented, for example, as a cellular telephone, or other mobile communication device, such as a computer or network enabled peripheral. Alternatively, user device 500 can be a non-mobile device, such as a desktop computer with wireless network connectivity. User device 500 has mobile processor 504, transmitter 506 and receiver 508, which are coupled to antenna 512 via coupler 510. User interface 502 is coupled to mobile processor 504 and provides interfaces to loudspeaker 514, microphone 516 and display 518, for example. Alternatively, user device 500 may have a different configuration with respect to user interface 502, or user interface 502 may be omitted entirely.

In embodiments of the present invention, mobile processor 504 is configured estimate and/or measure channel interference based on signals received via receiver 508. Alternatively, mobile processor 504 can be configured to derive CQI information for each sideband. In system embodiments that implement an OFDMA downlink, receiver 508 and mobile processor 504 downconverts and decodes OFDMA signals, and performs channel interference measurements in each subband of the received OFDMA signal. Interference measurements are then transmitted to the base station via transmitter 506. Alternatively, some systems implement an OFDMA uplink, or other technology types.

In an embodiment, user device 500 comprising a transmitter and a receiver is configured to measure an interference metric in a plurality of subbands and operate with a network and to receive an allocation of at least one of the usable subbands from a network. The network is configured to operate on the plurality of subbands, find an average interference level for each subband by polling the wireless user device for an interference metric, compare the average interference level for each subband with an interference threshold, and determine up to a first number of subbands whose interference level exceeds the interference threshold to determine a set of unusable subbands. The network is also configured to determine a set of usable subbands, wherein the usable subbands comprise the plurality of subbands that are not determined to be unsuitable subbands. In some embodiments, user device 500 is configured to operate with a broadband network. Alternatively, user device 500 can be configured to operate with other networks, such as a wireless LAN.

In further embodiments of user device 500, the interference metric comprises, for example a measured interference level, and/or channel quality information. In further embodiments, the set of unsuitable channels comprises up to the first number of subbands with the highest interference levels.

In further embodiments of user device 500, the network is further configured to determine a channel order from lowest interference levels to highest interference levels based on finding the interference metric for each channel, and allocate the channels to the user devices according to the channel order, wherein cell edge user devices are allocated channels with the lowest interference levels.

In an embodiment simulation, a network is represented as a grid layout of square cells. Each base station lies in the center of a square and has neighbors in the adjacent squares, however cells at the edge of the region have fewer neighbors. Typically, a wrap-around process is used so that all cells have the same number of neighbors. A simulation of the non wrap-around case, however, illustrates how an embodiment algorithm adapts to non-homogeneous loading since those cells at the edge of the network have less interfering neighbors than those in the center. It should be noted that embodiment simulations are illustrative of system performance even if the topology of the simulation does not exactly match the topology of the real system. For example, a real system may not necessarily contain square cells with a base station situated in the middle of the cell.

The path loss from each base station to each mobile user and the received signal strength and interference is computed. The path loss is modeled to be inversely proportional to distance to the power of 3.5. In the embodiment simulation, each cell independently updates its set of active subbands by computing the average interference for each subband and comparing with the threshold.

In the embodiment simulation, there are N=30 users per cell, K=12 subbands, and a total of 25 cells. The background noise level was chosen to achieve a spectral efficiency of approximately 1 bps/Hz if a user is at the cell edge and there is no interference. A maximum of eight subbands can be blocked from use by a sector in the embodiment simulation. The interference threshold used to determine whether or not a subband is blocked is normalized with respect to the maximum interference (over all users in all sectors) for the case in which all sectors transmit over all subbands. The default value of the threshold is set at one. A simple round robin scheduler is assumed; therefore the sector throughput is the average of the achievable mobile throughputs.

The following three performance metrics are obtained from the embodiment simulations: (a) The average sector throughput (this will be normalized by the sector throughput for the case where all sectors use all subbands), (b) the maximum interference level over all users over all sectors (normalized by the same metric for the case in which all sectors use all subbands) and (c) the bandwidth utilization (this is the ratio of the number of subbands that a sector is allowed to use divided by the total number of subbands). The average sector throughput indicates the overall system level performance. The second metric provides an indication of the outage that will be experienced for those applications (like VoIP) for which a specified goodput (e.g. 9.6 kbps) may be achieved by each user to achieve an acceptable level of user perceived performance. The bandwidth utilization metric indicates how the algorithm achieves increased cell edge performance by dynamically changing the frequency reuse factors of cells based on the loading due to surrounding cells.

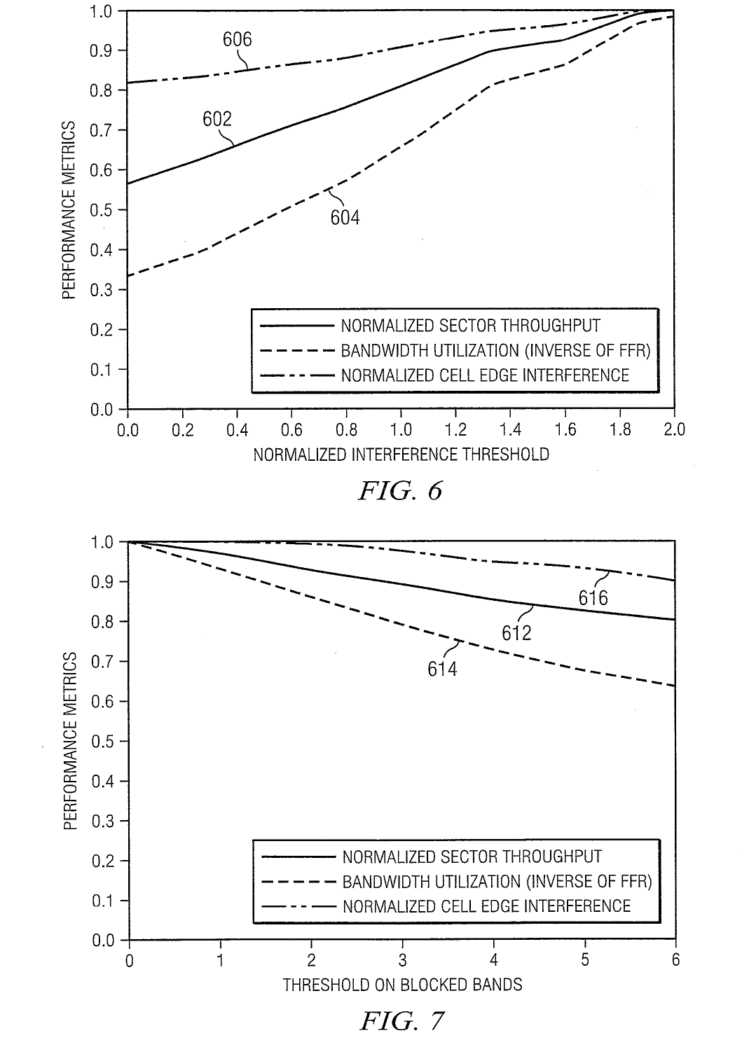

FIG. 6, which illustrates the dependence of performance on the interference threshold, shows three performance metrics as a function of the interference threshold: normalized sector throughput 602, bandwidth utilization 604 and normalized cell edge interference 606. Note that the interference threshold is normalized by the maximum interference over all users when all sectors use all subbands. When the threshold is zero, all sectors will block subbands up to the maximum allowed. For the baseline case this is 8 subbands out of 12 and hence the bandwidth utilization is ⅓ or a frequency reuse factor of 3. When the threshold is 2 (high) then none of the sectors have blocked subbands and hence the bandwidth utilization is one. As the normalized interference threshold increases from 0 to 2 the average sector throughput increases (good for overall system performance), but the interference level of the worst cell edge user also increases (increased outage). Note that as the frequency reuse factor increases from 1 to 3, the cell edge interference drops by approximately 20 percent. This translates into a significant improvement for cell edge users, which, in this particular example, comes at the cost of a 43% reduction in sector throughput.

FIG. 7 illustrates the effect of blocked bands on performance metrics for an embodiment system simulation. The performance metrics plotted are normalized sector throughput 612, bandwidth utilization 614 and normalized cell edge interference 616. In the embodiment simulation, the interference threshold is fixed at 1 and the maximum number of subbands that can be blocked by a sector is varied. In this case, the horizontal axis contains the maximum number of subbands that are allowed to be blocked. It can be seen that as the maximum number of sidebands allowed to be blocked is increased, the performance of cell edge users increases (less interference), the average sector throughout decreases and the bandwidth utilization drops.

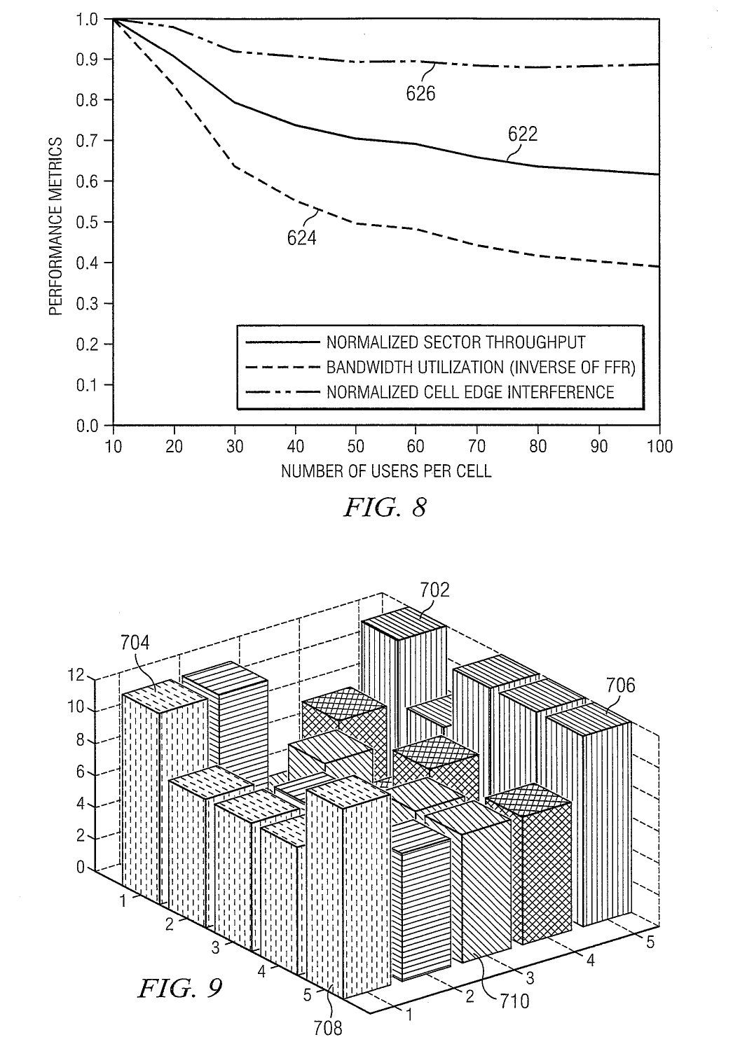

FIG. 8 illustrates the effect of number of users per cell on performance metrics for an embodiment system simulation. The performance metrics plotted are normalized sector throughput 622, bandwidth utilization 624 and normalized cell edge interference 626. The interference and subband thresholds are fixed and the number of users per cell is varied. In the embodiment simulation, cell edge interference performance essentially flattens as the number of users increases. As the user population increases, the worst-case user moves further away from its serving sector. Therefore, it becomes more difficult to maintain that user's throughput because of the increase in interference and the decrease in the signal from its serving sector. Embodiment algorithms, therefore, are essentially able to maintain the cell edge performance. Cell edge performance is maintained at a cost of reduced sector throughput, but is achieved through increasing frequency reuse factors.

To illustrate the distribution of frequency reuse factors among cells, the number of active subbands for each cell is plotted in the three dimensional bar graph of FIG. 9. Each bar represents a cell in the network, and the y-axis represents the number of active sidebands. In the embodiment simulation, the cells 702, 704, 706 and 708 at all four corners of the network use the full set of subbands (frequency reuse factor of 1), which is due to the corner cells being lightly loaded. The opposite is true for the cells in the center, for example, cell 710, because center cells block a subset of their subbands in order to provide acceptable interference to cell edge users in neighboring cells. It should be noted that performance in other embodiment system configurations may vary from simulated performance.

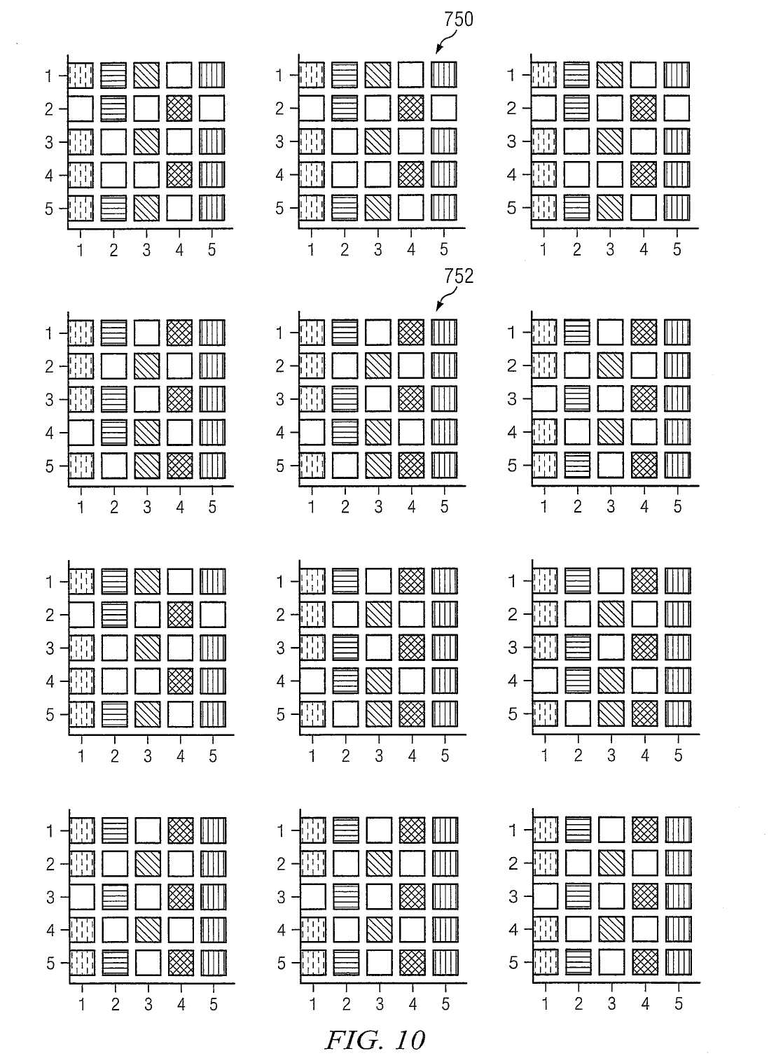

In FIG. 10, plots are provided for each of the 12 subbands. Each plot contains 25 squares representing the 25 cells. If a cell is white then that subband has been turned off in that particular cell, otherwise the subband is on. Here it can be seen that for each subband, an embodiment algorithm isolates a subset of cells so that these cells can achieve acceptable interference levels at their edges. This is done in such a way so that different sectors are isolated in different subbands so that each sector can achieve similar sector throughputs. However the sectors on the edge of the network can achieve even higher throughputs because they have fewer interferers and hence can use more bandwidth.

For example, consider the two subbands represented by plots 750 and 752 with respect to columns three and four of these subbands. The alternating on/off patterns for these cells are clearly apparent. In conventional FFR approaches, such a pattern would be enforced by coordination among the cells. Here, the pattern is achieved without coordination in this embodiment. Furthermore, note that the cells at the edge have almost all subbands switched on showing that the embodiment algorithm adapts to non-homogeneous loading. It should be noted, however, that in alternative embodiments of the present invention, some intercell coordination could also be used.

One advantage of embodiment systems and methods is that algorithms are self-adaptive and use different frequency reuse factors for different sectors based on surrounding conditions. Another advantage of embodiment algorithms is that they are fair in that the amount of bandwidth sacrificed by each sector is limited. A further advantage is that embodiment algorithms do not require intercell (or cross-sector) coordination, wherein each sector infers adjacent sector loading information through measurements reported by its users.

It should be noted that embodiment systems and methods could be used for a variety of systems. For example embodiment algorithms can be applied toward the uplink, as well as the downlink, signal path of wireless communication systems. Furthermore it can also be applied to wireless relay systems and cognitive radio networks.

Although present embodiments and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of operating a base station configured to support a plurality of user devices on a plurality of channels, the method comprising:
finding an interference metric for each channel;
comparing the interference metric for each channel with an interference threshold;
determining up to a first number of channels whose interference metric exceeds the interference threshold to determine a set of unsuitable channels;
determining a set of usable channels, the usable channels comprising the plurality of channels that are not determined to be unsuitable channels; and
allocating the usable channels to the plurality of user devices.

2. The method of claim 1, wherein the plurality of channels comprise subbands.

3. The method of claim 1, further comprising transmitting to the user devices using an orthogonal frequency division multiple access (OFDMA) system.

4. The method of claim 1, wherein finding the interference metric for each channel comprises finding an average interference level for each channel.

5. The method of claim 4, wherein finding the average interference level for each channel comprises polling user devices for interference levels.

6. The method of claim 4, wherein finding the average interference level for each channel comprises polling user devices for a channel quality information (CQI).

7. The method of claim 1, wherein the set of unsuitable channels comprises up to the first number of channels with the highest interference metric.

8. The method of claim 1, wherein allocating the usable channels to the plurality of user devices comprising:
determining a channel order from lowest interference levels to highest interference levels based on finding the interference metric for each channel; and
allocating channels to user devices according to the channel order, wherein cell edge user devices are allocated channels with the lowest interference levels.

9. The method of claim 1, wherein determining up to a first number of channels provides a lower limit on the minimum number of usable subbands.

10. A method of operating a wireless network configured to operate on a plurality of subbands:
finding an average interference metric for each subband;
comparing the average interference metric for each subband with an interference threshold;
determining up to a first number of subbands whose interference metric exceeds the interference threshold to determine a set of unsuitable subbands;
determining a set of usable subbands, the usable subbands comprising the plurality of subbands that are not determined to be unsuitable subbands; and
allocating the usable subbands to user devices.

11. The method of claim 10, wherein finding the average interference metric for each subband comprises:
polling the user devices for interference levels to determine reported interference levels; and
averaging reported interference levels among user devices.

12. The method of claim 10, wherein finding the average interference metric for each subband comprises:
polling the user devices for channel quality information (CQI) to determine reported interference metrics;
deriving equivalent interference levels for each user device based on the polled CQI; and
averaging the equivalent interference levels among user devices.

13. The method of claim 10, wherein the set of unsuitable subbands comprises up to the first number of subbands with the highest interference metrics.

14. The method of claim 10, wherein allocating the usable subbands to the user devices comprises:
determining a channel order from lowest interference levels to highest interference levels based on finding the interference metric for each channel; and
allocating subbands to user devices according to the channel order, wherein cell edge user devices are allocated channels with the lowest interference metrics.

15. The method of claim 10, wherein allocating the usable subbands is performed by a base station of the wireless network.

16. The method of claim 10, wherein the network operates according to a long-term evolution (LTE) standard.

17. The method of claim 10, wherein further comprising a base station transmitting to the user devices using an orthogonal frequency division multiple access (OFDMA) downlink, wherein the plurality of subbands comprise subbands of an OFDMA channel.

18. The method of claim 10, wherein the plurality of subbands comprise subbands of an uplink channel.

19. The method of claim 10, wherein the wireless network comprises a plurality of base stations.

20. A wireless base station comprising:
a transmitter configured to transmit to user devices; and
a receiver configured to receive transmissions from user devices, wherein the base station is configured to:
operate on a plurality of channels,
find an average interference metric for each channel,
compare the average interference metric for each channel with an interference threshold,
determine up to a first number of channels whose interference metric exceeds the interference threshold to determine a set of unsuitable channels, and
determine a set of usable channels, wherein the usable channels comprise the plurality of channels that are not determined to be unsuitable channels; and
allocate the usable channels to user devices.

21. The wireless base station of claim 20, wherein the wireless base station is further configured to poll the user devices for interference levels measured by the user devices to determine the average interference metric for each channel.

22. The wireless base station of claim 20, wherein the wireless base station is further configured to poll the user devices for channel quality information (CQI) derived by the user devices to determine the average interference metric for each channel.

23. The wireless base station of claim 20, wherein the set of unsuitable channels comprises the first number of channels with the highest interference metrics.

24. The wireless base station of claim 20, wherein the base station is further configured to:
determine a channel order from lowest interference metrics to highest interference metrics based on finding the interference metric for each channel; and
allocate the channels to the user devices according to the channel order, wherein cell edge user devices are allocated channels with the lowest interference metrics.
